(19) United States
(12) Patent Application Publication
(10) Pub. No.: US 2010/0065354 A1
(43) Pub. Date: Mar. 18, 2010

(54) DRIVING DEVICE FOR VEHICLE

(75) Inventor: Masafumi SAKUMA, Chiryu-shi (JP)

Correspondence Address: BUCHANAN, INGERSOLL & ROONEY PC, POST OFFICE BOX 1404, ALEXANDRIA, VA, 22313-1404, US

(73) Assignee: AISIN SEIKI KABUSHIKI KAISHA, Kariya-shi (JP)

(21) Appl. No.: 12/557,098

(22) Filed: Sep. 10, 2009

(30) Foreign Application Priority Data
Sep. 18, 2008 (JP) 2008-239693

(51) Int. Cl. B60K 6/48

(52) U.S. Cl. 180/65.25; 180/65.21

(57) ABSTRACT

A driving device for a vehicle includes an engine outputting a rotational driving force for driving the vehicle, a transmission apparatus having an input shaft connectable to an output shaft of the engine, changing a rotational speed of the input shaft of the transmission apparatus and transmitting the changed rotational speed to an output member, a rotating electrical mechanism having a rotating shaft, which has an axis that differs from an axis of the input shaft of the transmission apparatus, and a reduction mechanism reducing a rotational speed of the rotating shaft of the rotating electrical mechanism and transmitting the reduced rotational speed to the input shaft of the transmission apparatus.

### CROSS REFERENCE TO RELATED APPLICATIONS

This application is based on and claims priority under 35 U.S.C. §119 to Japanese Patent Application 2008-239693, filed on Sep. 18, 2008, the entire content of which is incorporated herein by reference.

### TECHNICAL FIELD

This disclosure generally relates to a driving device for a vehicle. More specifically, this disclosure pertains to a driving device adaptable to a hybrid vehicle.

### BACKGROUND

Generally, there exist a hybrid vehicle, an electric vehicle and the like using a rotating electrical mechanism as a power source, which are considered to be effective in view of energy efficiency and energy conservation and in view of global warming. The hybrid vehicle is a vehicle having the rotating electrical mechanism, which is driven by an electric energy, as a power source in addition to a conventional engine using fossil fuel as a fuel. In other words, the hybrid vehicle is a vehicle that generates a rotational force in a manner where an inverter converts a direct current voltage, which is outputted by a battery provided at the vehicle, into an alternating current voltage, and then, the rotating electrical mechanism is rotated by the converted alternating current voltage, in addition to generating a rotational force by driving the engine. On the other hand, the electric vehicle is a vehicle that does not include an engine and that uses only the electric energy as the power source. For example, disclosed in JP2006-160096A, JP2005-57832A and “Development of Parallel Hybrid System for Small-Sized Truck” (Hino Motors, Ltd., 20035246, Society of Automotive Engineers Spring Conference 2003) are technologies relating to the hybrid vehicle and the electric vehicle.

According to a driving device for a hybrid vehicle disclosed in JP2006-160096A, an electric motor is disposed between an engine and a transmission apparatus. Similarly, according to an electric motor and a hybrid vehicle having the same disclosed in JP2005-57832A, an electric motor is disposed between an engine and a transmission apparatus. Furthermore, according to the parallel hybrid system for the small-sized truck (2003, Hino Motors, Ltd.), a motor is disposed between an engine and a transmission apparatus. The hybrid systems disclosed in JP2006-160096A, JP2005-57832A and “Development of Parallel Hybrid System for Small-Sized Truck” (Hino Motors, Ltd., 2003) are referred to as a parallel hybrid system, in which wheels are rotated by the engine and the motor in response to a traveling state of the vehicle. For example, in the parallel hybrid system, the motor is actuated in a case where a load is applied to the engine, such as a case where the vehicle starts moving or where a speed of the vehicle is accelerated, in order to assist a driving force of the engine. On the other hand, in a case where an efficiency of the engine (i.e. an engine performance) is low, e.g. such a case where the vehicle travels at a low speed, a rotational speed of the engine is increased and the motor is rotated as a generator, so that the generated electric energy is charged in the battery, thereby increasing an efficiency of the energy. Furthermore, energy is retrieved through a regenerative braking such as in a case where a braking operation is performed or in a case where the vehicle travels downhill, or the engine is stopped in a case where the vehicle is stopped in order to increase the energy efficiency.

As described above, according to JP2006-160096A, JP2005-57832A and the parallel hybrid system for the small-sized truck (Hino Motors, Ltd. 2003), the hybrid system includes the motor that is disposed between the engine and the transmission apparatus. In the hybrid system disclosed in JP2006-160096A, JP2005-57832A and the parallel hybrid system for the small-sized truck (Hino Motors, Ltd. 2003), a rotational speed of the motor and the rotational speed of the engine are set to be the same level because of a structure of the hybrid system in view of assembling. Accordingly, the motor may not be driven at a high speed. On the other hand, in order to achieve a motor high speed operation, it may be conceivable to provide a reduction mechanism between the engine and the motor. However, according to the driving device for the hybrid vehicle disclosed in JP2006-160096A, the electric motor and the hybrid vehicle having the same disclosed in JP2005-57832A and the parallel hybrid system for the small-sized truck (Hino Motors, Ltd. 2003), it may not be easy to provide such reduction mechanism between the engine and the motor because a sufficient space for the reduction mechanism is hard to be ensured. Therefore, in the hybrid system disclosed in JP2006-160096A, JP2005-57832A and the parallel hybrid system for the small-sized truck (Hino Motors, Ltd. 2003), the motor is unlikely to be driven at high speed.

Furthermore, according to the hybrid systems disclosed in JP2006-160096A, JP2005-57832A and the parallel hybrid system for the small-sized truck (Nino Motors, Ltd. 2003), an output of the motor to be generated is determined on the basis of the engine and the transmission apparatus. Therefore, various motors need to be manufactured in order to be adapted to various combinations of the engines and the transmission apparatuses. In other words, adapting limited types of motors to various combinations of the engines and transmission apparatuses is not easy in view of a structure of the motor and a function (performance) of the motor.

A need thus exists to provide a driving device for a vehicle which is not susceptible to the drawback mentioned above.

### SUMMARY

According to an aspect of this disclosure, a driving device for a vehicle includes an engine outputting a rotational driving force for driving the vehicle, a transmission apparatus having an input shaft connectable to an output shaft of the engine, changing a rotational speed of the input shaft of the transmission apparatus and transmitting the changed rotational speed to an output member, a rotating electrical mechanism having a rotating shaft, which has an axis that differs from an axis of the input shaft of the transmission apparatus, and a reduction mechanism reducing a rotational speed of the rotating shaft of the rotating electrical mechanism and transmitting the reduced rotational speed to the input shaft of the transmission apparatus.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a diagram schematically illustrating a configuration example of a driving device for a vehicle;

FIG. 2 is a diagram illustrating a cross-sectional diagram of a rotating electrical mechanism and the surrounding components;

FIG. 3 is a cross-sectional diagram taken along line in FIG. 2;

FIG. 4 is a diagram illustrating a configuration example of a single-phase rotating electrical mechanism;

FIG. 5 is a diagram illustrating a connection in a case where three of the single-phase rotating electrical mechanisms are driven as a single three-phase rotating electrical mechanism;

FIG. 6 is a diagram illustrating a Y-connection configured by three of the single-phase rotating electrical mechanisms;

FIG. 7 is a diagram illustrating a connection among a control portion, a frequency converting portion and the single-phase rotating electrical mechanism;

FIG. 8 is a diagram illustrating a configuration example of a single-phase rotating electrical mechanism that does not include an auxiliary electrode;

FIG. 9 is a diagram illustrating a configuration example of a three-phase rotating electrical mechanism;

FIG. 10 is a diagram illustrating a connection of three of the three-phase rotating electrical mechanisms in a case where U-phase terminals of three of the three-phase rotating electrical mechanisms are connected in parallel, V-phase terminals of three of the three-phase rotating electrical mechanisms are connected in parallel and W-phase terminals of three of the three-phase rotating electrical mechanisms are connected in parallel;

FIG. 11 is a diagram schematically illustrating the connection of three of the three-phase rotating electrical mechanisms in a case where U-phase terminals of three of the three-phase rotating electrical mechanisms are connected in parallel, V-phase terminals of three of the three-phase rotating electrical mechanisms are connected in parallel and W-phase terminals of three of the three-phase rotating electrical mechanisms are connected in parallel;

FIG. 12 is a diagram illustrating a connection of three of the three-phase rotating electrical mechanisms in a case where U-phase terminals of three of the three-phase rotating electrical mechanisms are connected in series, V-phase terminals of three of the three-phase rotating electrical mechanisms are connected in series and W-phase terminals of three of the three-phase rotating electrical mechanisms are connected in series;

FIG. 13 is a diagram schematically illustrating the connection of three of the three-phase rotating electrical mechanisms in a case where U-phase terminals of three of the three-phase rotating electrical mechanisms are connected in series, V-phase terminals of three of the three-phase rotating electrical mechanisms are connected in series and W-phase terminals of three of the three-phase rotating electrical mechanisms are connected in series;

FIG. 14 is a diagram illustrating a case where six rotating electrical mechanisms are used; and

FIG. 15 is a view illustrating a configuration example of a reduction mechanism according to another embodiment.

### DETAILED DESCRIPTION

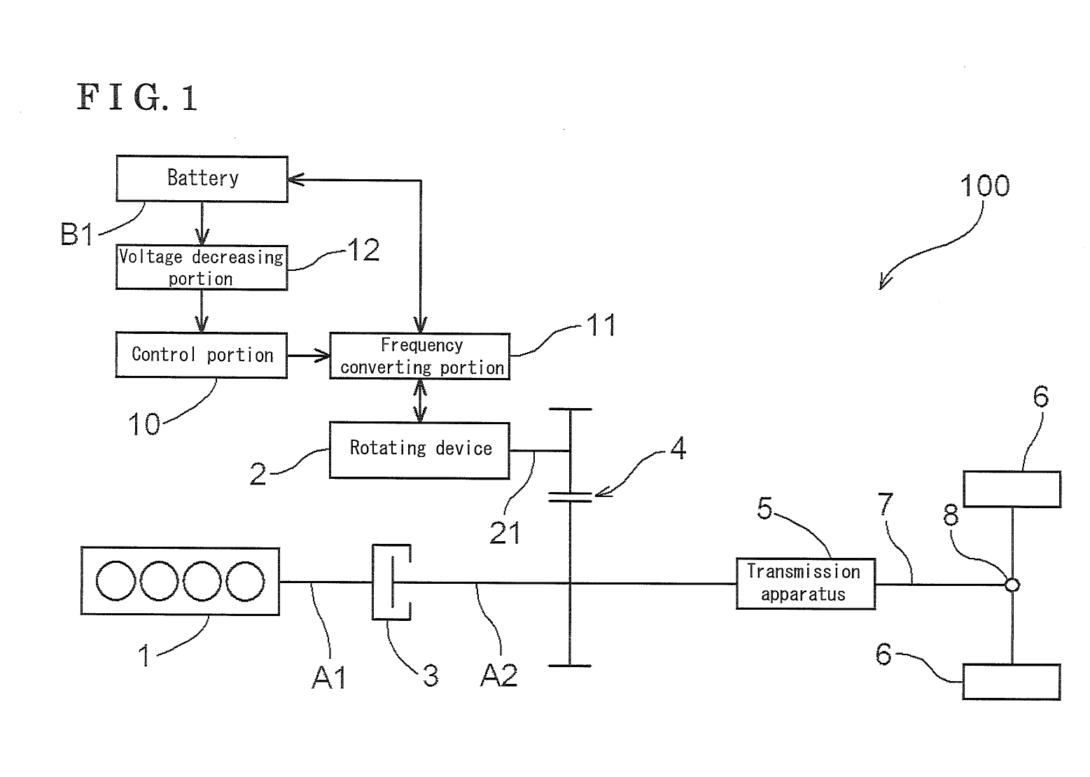

An embodiment of a driving device for a vehicle (which will be hereinafter referred to simply as a driving device) will be described below. A driving device 100 is adapted to a hybrid vehicle (which will be hereinafter referred to simply as a vehicle). Furthermore, the driving device 100 includes an engine 1, which uses fossil fuel as driving energy, and a rotating electrical mechanism 2, which uses electric energy as the driving energy. A schematic configuration of the driving device 100 will be described below with reference to FIG. 1.

As illustrated in FIG. 1, the driving device 100 includes the engine 1 and the rotating electrical mechanism 2 as a driving power source for driving the vehicle. The engine 1 is connected to a reduction mechanism 4 via a connecting clutch 3. The rotating electrical mechanism 2 is configured so that a rotational force generated by the rotating electrical mechanism 2 is transmittable to the reduction mechanism 4. Accordingly, the engine 1 and the rotating electrical mechanism 2 are mechanically connected via the connecting clutch 3. In other words, the driving device 100 is adaptable to a vehicle having a parallel hybrid system.

As described above, the engine 1 uses the fossil fuel as the driving energy. The fossil fuel refers to gasoline in a case where a gasoline engine is used as the engine 1. On the other hand, in a case where a diesel engine is used as the engine 1, the fossil fuel refers to diesel fuel. Further, in a case where a liquefied petroleum gas engine (i.e. a LP gas engine) is used as the engine 1, the fossil fuel refers to liquefied petroleum gas (i.e. LP gas). The engine 1 outputs a rotational force for driving the hybrid vehicle by combusting the fossil fuel. The rotational driving force generated by the engine 1 is outputted to the connecting clutch 3 via an output shaft A1, which is connected to a crankshaft of the engine 1.

The rotating electrical mechanism 2 is electrically connected to a storage device such as a battery B1, a capacitor and the like. Hereinafter, the storage device will be referred to as the battery B1. The rotating electrical mechanism 2 functions as a motor, which generates a driving force, when receiving an electric power. On the other hand, the rotating electrical mechanism 2 functions as a generator, which generates the electric power, when receiving the driving force.

The battery B1 is configured so as to output a predetermined voltage (e.g. voltage equal to or greater than 270 V) by plural battery cells, each of which generates an output voltage of a few voltages and which are connected in series and in parallel. Furthermore, the battery B1 is used as a driving source for driving the rotating electrical mechanism 2. Additionally, an output of the battery B1 may be used as a power source for driving an electric equipment such as an air conditioner and the like, which is provided at the hybrid vehicle and which has a relatively great power consumption.

The connecting clutch 3 is disposed between the engine 1 and the rotating electrical mechanism 2, so that a power transmission between the engine 1 and wheels 6 is established and interrupted in response to an operation of the connecting clutch 3. The driving device 100 is configured so that, in a case where the vehicle starts moving or in a case where the vehicle travels at a low speed, the connecting clutch 3 is disengaged and the engine 1 is stopped. Therefore, only the rotational driving force generated by the rotating electrical mechanism 2 is transmitted to the wheels 6, thereby driving the vehicle. More specifically, in this case, the rotating electrical mechanism 2 generates the driving force by receiving the electric power supply from the battery B1. Then, when the connecting clutch 3 is engaged while the rotational speed of the rotating electrical mechanism 2 (i.e. a traveling speed (a moving speed) of the vehicle) becomes equal to or greater than a predetermined rotational speed, the engine 1 is cranked, so that the engine 1 is started. After the engine 1 is started, the rotational driving forces generated by the engine 1 and the rotating electrical mechanism 2 are both transmitted to the wheels 6, thereby driving the vehicle. In this case, the rotating electrical mechanism 2 may be turned to be a state where the rotating electrical mechanism 2 generates the electric power in response to the rotational driving force generated by the engine 1 or a state where the rotating electrical mechanism 2 generates the driving force in response to the electric power supplied thereto from the battery B1, depending on a charging status of the battery B1. Furthermore, in a case where the traveling speed of the vehicle is decelerated, the connecting clutch 3 is disengaged and the engine 1 is stopped, so that the rotating electrical mechanism 2 turns to a state where the rotating electrical mechanism 2 generates the electric power in response to a rotational driving force transmitted thereto from the wheels 6. An alternating current power generated by the rotating electrical mechanism 2 is converted into a direct current power at a frequency converting portion 11, so that the converted direct current power is stored at the battery B1. Still further, in a case where the vehicle is stopped, the engine 1 and the rotating electrical mechanism 2 are both stopped, and the connecting clutch 3 is disengaged.

A transmission apparatus 5 is provided at a downstream side of the power transmission relative to the connecting clutch 3. The transmission apparatus 5 includes an input shaft A2, which is configured so as to be connected to the output shaft A1 of the engine 1. Furthermore, the transmission apparatus 5 changes a rotational speed generated at the input shaft A2 and then, transmits the changed rotational speed to an output member 7. As described above, the output shaft A1 of the engine 1 and the input shaft A2 of the transmission apparatus 5 are connectable by engaging the connecting clutch 3. In the case where the connecting clutch 3 is engaged, the rotational driving force generated by the engine 1 is transmitted to the transmission apparatus 5 via the input shaft A2. On the other hand, in the case where the connecting clutch 3 is disengaged, the rotational driving force generated by the rotating electrical mechanism 2 is transmitted to the input shaft A2 while a speed of the rotational driving force generated by the rotating electrical mechanism 2 is decelerated at a predetermined reduction ratio by the reduction mechanism 4. An automatic transmission apparatus may be used as the transmission apparatus 5. In the case where the automatic transmission apparatus is used as the transmission apparatus 5, the transmission apparatus 5 is configured with a torque converter, a transmission mechanism and the like. The torque converter is filled with operation oil therewithin. Furthermore, the torque converter transmits a driving force between a pump impeller, which is provided at a driving side of the torque converter (i.e. at a portion of the torque converter positioned in the vicinity of the input shaft A2), and a turbine runner, which is provided at a driven side of the torque converter (i.e. at a portion of the torque converter positioned in the vicinity of the transmission mechanism) via the operation oil which is provided inside of the torque converter.

The transmission mechanism is provided at the downstream side of the power transmission relative to the torque converter. Accordingly, the rotation of the driving force transmitted to the transmission mechanism from the source of the driving force via the torque converter is changed at the predetermined reduction ratio by the transmission mechanism, and then, the transmission mechanism transmits the rotation to the wheels 6. The transmission mechanism is configured as an automatic transmission apparatus having a shift stage. More specifically, the transmission mechanism includes a clutch and a frictionally-engaging component such as a brake and the like. The clutch of the transmission mechanism engages and disengages a rotating component of a gear mechanism, which establishes a transmission gear ratio of each shift stage. The frictionally-engaging component of the transmission mechanism is controlled on the basis of a hydraulic pressure of the operation oil. Alternatively, an automatic transmission apparatus having no shift stage (i.e. a continuously variable transmission apparatus) may be used as the transmission mechanism. Still further, in the case where the clutch is provided at the transmission mechanism, the driving device 100 may be configured so that the rotating electrical mechanism 2 starts the engine 1 by interrupting the power transmission path.

The output member 7 is provided at the downstream side of the power transmission path relative to the transmission apparatus 5. Furthermore, the output member 7 is connected to the wheels 6 via a deferential device 8. Accordingly, the speed of the rotational driving force transmitted to the transmission apparatus 5 from the source of the driving force is changed by the transmission apparatus 5, and then, the rotational driving force is transmitted to the output member 7. The rotational driving force transmitted to the output member 7 is further transmitted to the wheels 6 via the differential device 8.

In order to increase a torque generated by the rotating electrical mechanism 2, an electric current supplied to the rotating electrical mechanism 2 may need to be increased. On the other hand, an impedance of a coil C, which is provided at a stator S of the rotating electrical mechanism 2, is set to be constant. Therefore, in order to increase the torque generated by the rotating electrical mechanism 2, a voltage supplied to the rotating electrical mechanism 2 may need to be increased. In other words, by increasing the voltage supplied to the rotating electrical mechanism 2, an electromagnetic force may be increased because the electric current supplied to the coil C is increased. Accordingly, the vehicle having the driving device 100 of the embodiment includes the battery B1, whose output voltage is set to be a relatively high degree (e.g. a voltage equal to or greater than 270V). The output voltage of the battery B1 is supplied to the rotating electrical mechanism 2 via the frequency converting portion 11. More specifically, the frequency converting portion 11 converts a direct current voltage, which is outputted from the battery B1, into an alternating current voltage having a predetermined frequency.

The frequency converting portion 11 is controlled by a control portion 10. The control portion 10 is configured with a microcomputer for controlling an operation of a transistor of the frequency converting portion 11. If a high voltage outputted by the battery B1 is directly inputted into the control portion 10, the high voltage may exceed an absolute maximum rating of the microcomputer, which may result in causing an electrical breakdown of the microcomputer. Therefore, in order to prevent an occurrence of the electrical breakdown of the microcomputer, the output voltage (the high voltage) of the battery B1 is decreased to a predetermined voltage by a voltage decreasing portion 12, so that the predetermined voltage is inputted into the control portion 10. The voltage decreasing portion 12 includes a function of decreasing the output voltage (e.g. the voltage equal to or greater than 270V) of the battery B1 to a low voltage (e.g. 2.5 V, 3.3 V and the like). Therefore, the voltage decreasing portion 12 may be configured with, for example, a regulator element. Alternatively, the voltage decreasing portion 12 may be configured with a voltage decreasing DC/DC converter and the like.

The output of the rotating electrical mechanism 2 is outputted as the rotational driving force. However, a rotational speed of the rotational driving force, which is outputted by the rotating electrical mechanism 2, is very high when comparing to the rotational speed of the engine 1. Therefore, the rotational driving force generated by the rotating electrical mechanism 2 is not transmittable to the transmission apparatus 5 while maintaining the high rotational speed. Furthermore, in a case where the rotating electrical mechanism 2 is rotated as the generator in response to the rotational driving force of the engine 1, the rotating electrical mechanism 2 may preferably be rotated at a speed equal to or greater than a predetermined rotational speed in order to enhance power generation efficiency. Therefore, according to the embodiment, the reduction mechanism 4 is disposed between the input shaft A2 of the transmission apparatus 5 and a rotating shaft 21 of the rotating electrical mechanism 2 in order to decrease a rotational speed of the rotating shaft 21 of the rotating electrical mechanism 2, so that the decreased rotational speed of the rotating shaft 21 is transmitted to the input shaft A2 of the transmission apparatus 5.

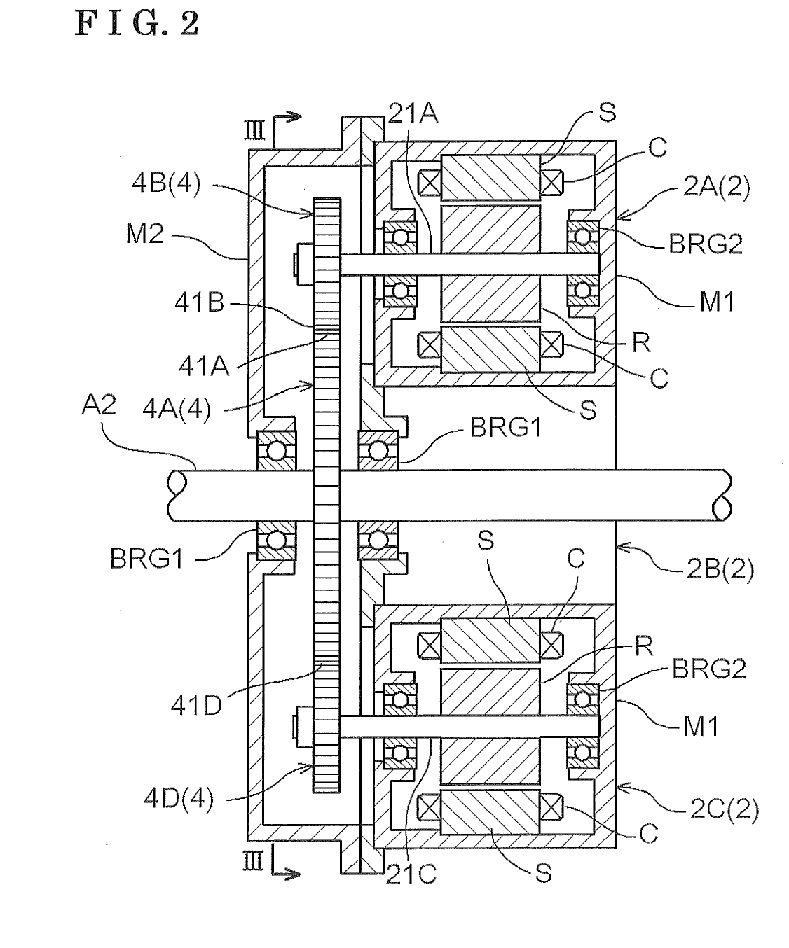

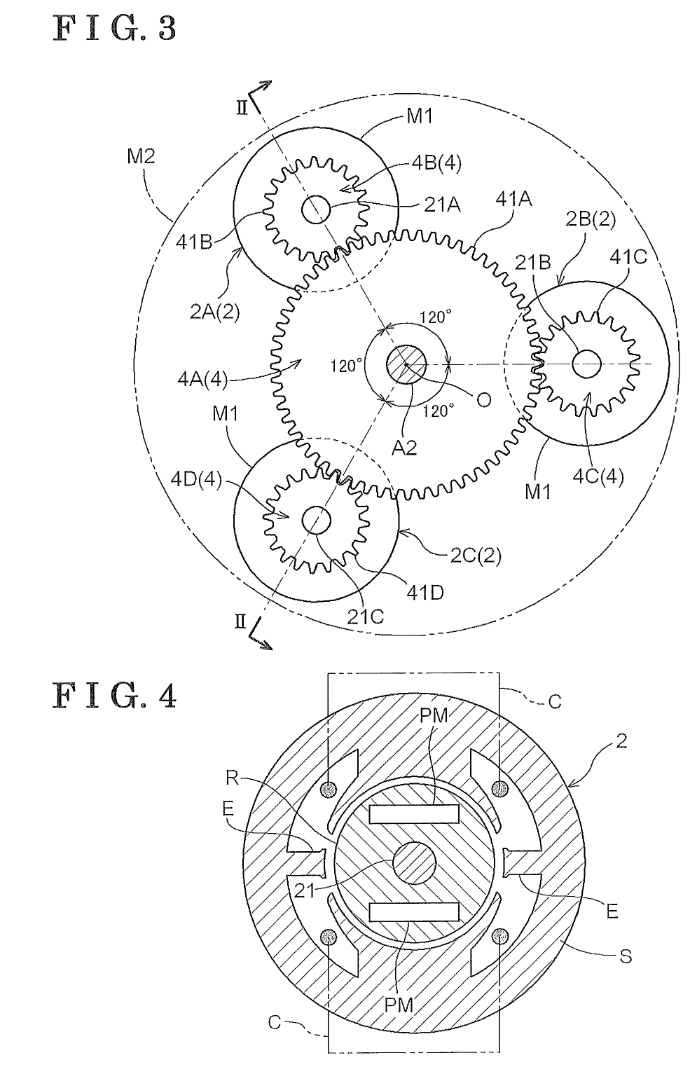

An arrangement of the rotating electrical mechanism 2, the reduction mechanism 4 and the input shaft A2 of the transmission apparatus 5 will be described below with reference to FIGS. 2 and 3. According to the embodiment, the rotating electrical mechanism 2 of the driving device 100 is configured with plural rotating electrical mechanisms (2). By configuring the rotating electrical mechanism 2 to include plural rotating electrical mechanisms (2), a necessary torque may be separately generated by plural and small-sized rotating electrical mechanisms (2). In other words, each of plural rotating electrical mechanisms (2) outputs a predetermined torque so that the total torque corresponds to the necessary torque to be generated. As a result, the rotating electrical mechanism 2 of the embodiment may be allowed to be arranged (adapted) to various driving devices having any size of available space for accommodating the rotating electrical mechanisms 2. In other words, a large space does not need to be prepared for assembling the rotating electrical mechanism 2 of the embodiment to any types of driving device. Overall, a size of the driving device 100 may be decreased. Hereinafter, a case where the rotating electrical mechanism 2 is configured with three rotating electrical mechanisms (first, second and third rotating electrical mechanisms 2A, 2B and 2C) will be described as an example.

Illustrated in FIG. 2 is a cross-sectional diagram of the rotating electrical mechanisms 2A, 2B and 2C, the reduction mechanism 4 and the surrounding components when being viewed in a direction orthogonal to an axial direction of the input axis A2. More specifically, illustrated in FIG. 2 is the cross-sectional diagram of the rotating electrical mechanisms 2A, 2B and 2C, the reduction mechanism 4 and the surrounding components taken along line II-O-II in FIG. 3. Illustrated in FIG. 3 is a cross-sectional diagram illustrating the rotating electrical mechanism 2 taken along line III-III in FIG. 2. As illustrated in FIGS. 2 and 3, the first, second and third rotating electrical mechanisms 2A, 2B and 2C are arranged on a concentric circle having an axis of the input shaft A2 of the transmission apparatus 5 as a center point. Furthermore, as illustrated in FIG. 3, the first, second and third rotating electrical mechanisms 2A, 2B and 2C are preferably provided at regular intervals along a circumferential direction of the input shaft A2 of the transmission apparatus 5. More specifically, in the case where the rotating electrical mechanism 2 is configured with three rotating electrical mechanisms as in this embodiment, the first, second and third rotating electrical mechanisms 2A, 2B and 2C are arranged so as to form an angle of 120 degrees between the neighboring rotating electrical mechanisms with reference to the input shaft 2A of the transmission apparatus 5 in order to keep the same distance therebetween. Accordingly, a stress applied to the input shaft A2 of the transmission apparatus 5 from each of the first, second and third rotating electrical mechanisms 2A, 2B and 2C is set to be equal to each other. Therefore, an occurrence of a mechanical damage to a bearing BRG1 of the input shaft A2 by the stress applied thereto may be avoided.

The first, second and third rotating electrical mechanisms 2A, 2B and 2C include first, second and third rotating shafts 21A, 21B and 21C, respectively. Each of the first, second and third rotating shafts 21A, 21B and 21C includes an axis differs from the axis of the input shaft 2A of the transmission apparatus 5. In other words, the axis of each of the first, second and third rotating shafts 21A, 21B and 21C does not correspond with the axis of the input shaft A2 of the transmission apparatus 5. More specifically, the axis of the input shaft A2 of the transmission apparatus 5 is not commonly used as the axis of each of the first, second and third rotating shafts 21A, 21B and 21C.

Each of the first, second and third rotating electrical mechanisms 2A, 2B and 2C includes a rotor R and the stator S. The rotor R includes a permanent magnet PM. The stator S includes the coil C. An alternating current is supplied to the coil C in response to the alternating current voltage, which is converted by the frequency converting portion 11 and which has the predetermined frequency, so that each of the first, second and third rotating electrical mechanisms 2A, 2B and 2C is rotatably driven in response to an attraction force and a repulsive force generated between the permanent magnet PM and the coil C. Each of the first, second and third rotating electrical mechanisms 2A, 2B and 2C, which are rotatably driven as mentioned above, is supported by a case M1 covering the first, second and third rotating electrical mechanisms 2A, 2B and 2C and a supporting member M2 for supporting the output shaft A1 so as to be rotatable via the bearing BRG1, in order to maintain a relative positional relationship between the output shaft A1 and each of the first, second and third rotating shafts 21A, 21B and 21C. Additionally, each of the first, second and third rotating shafts 21A, 21B and 21C of the respective first, second and third rotating electrical mechanisms 2A, 2B and 2C is supported by a bearing BRG2, while allowing each of the first, second and third rotating shafts 21A, 21B and 21B to rotate relative to the case M1.

The input shaft A2 of the transmission apparatus 5 and the first, second and third rotating shafts 21A, 21B and 21C of the respective first, second and third rotational devices 2A, 2B and 2C are arranged so that the rotational driving force is mutually transmittable therebetween via the reduction mechanism 4. As described above, the reduction mechanism 4 is configured so as to reduce the rotational speed of each of the rotating shafts 21A, 21B and 21C of the respective rotating electrical mechanisms 2A, 2B and 2C and then, transmit the reduced rotational speed to the input shaft A2 of the transmission apparatus 5.

The reduction mechanism 4 is configured with a first gear 4A and plural second gears 4B, 4C and 4D, so that the first gear 4A is engaged with each of the second gears 4B, 4C and 4D. The first gear 4A is provided at the input shaft A2 of the transmission apparatus 5. The second gears 4B, 4C and 4D are provided at the first, second and third rotating shafts 21A, 21B and 21C of the first, second and third rotating electrical mechanisms 2A, 2B and 2C, respectively. Furthermore, a number of teeth formed at the first gear 4A is set to be greater than a number of teeth formed at each of the second gears 4B, 4C and 4D.

An outer circumferential surface of the first gear 4A, which is provided at the input shaft A2 of the transmission apparatus 5, in a radial direction of the first gear 4A serves as a first engaging portion 41A. On the other hand, an outer circumferential surface of the second gear 4B, which is provided at the rotating shaft 21A of the rotating electrical mechanism 2A, in a radial direction of the second gear 4B serves as a second engaging portion 41B. Similarly, an outer circumferential surface of the second gear 4C, which is provided at the second rotating shaft 21C of the rotating electrical mechanism 2C, in a radial direction of the second gear 4C serves as a third engaging portion 41C. Furthermore, an outer circumferential surface of the second gear 4D, which is provided at the third rotating shaft 21c of the third rotating electrical mechanism 2C, in a radial direction of the second gear 4D serves as a fourth engaging portion 41D. In a case where each of the first, second and third rotating electrical mechanisms 2A, 2B and 2C is controlled to be rotated at the same speed, the number of the teeth formed at each of the second, third and fourth engaging portions 41B, 41C and 41D is set to be the same. The first engaging portion 41A is engaged with each of the second, third and fourth engaging portions 41B, 41C and 41D. Therefore, in a case where each of the first, second and third rotating electrical mechanisms 2A, 2B and 2C functions as the motor, the first, second and third rotating electrical mechanisms 2A, 2B and 2C rotate the input shaft A2 of the transmission apparatus 5 in conjunction with each other. On the other hand, in a case where each of the first, second and third rotating electrical mechanisms 2A, 2B and 2C functions as the generator, the input shaft A2 of the transmission apparatus 5 rotates each of the first, second and third rotating electrical mechanisms 2A, 2B and 2C.

In this embodiment, each of the first, second and third rotating electrical mechanisms 2A, 2B and 2C is controlled by the control portion 10 so that each of the first, second and third rotating electrical mechanisms 2A, 2B and 2C rotates at the same speed. Therefore, in a case where each of the first, second and third rotating shafts 21A, 21B and 21C of the respective first, second and third rotating electrical mechanisms 2A, 2B and 2C is rotated in a clockwise direction in FIG. 3, each of the second gears 4B, 4C and 4D, which is configured so as to have an identical axis with each of the first, second and third rotating shafts 21A, 21B and 21C, is also rotated in the clockwise direction. Accordingly, the first gear 4A having the first engaging portion 41A, which is engaged with each of the second, third and fourth engaging portions 41B, 41C and 41D of the respective second gears 4B, 4C and 4D, is rotated in a counterclockwise direction in FIG. 3. The rotational driving force generated as mentioned above is transmitted to the input shaft A2 of the transmission apparatus 5.

The rotational speed of each of the first, second and third rotating shafts 21A, 21B and 21C of the respective first, second and third rotating electrical mechanisms 2A, 2C and 2D is set to be very high in order to rotate each of the first, second and third rotating electrical mechanisms 2A, 2B and 2C at a high speed. Accordingly, in the case where the rotational speed of the first, second and third rotating shafts 21A, 21B and 21C is transmitted to the input shaft A2 of the transmission apparatus 5, the rotational speed of each of the first, second and third rotating shafts 21A, 21B and 21C needs to be reduced to a predetermined rotational speed. Therefore, the number of teeth formed at the first gear 4A of the reduction mechanism 4 is set to be greater than the number of teeth formed at each of the second gears 4B, 4C and 4D of the reduction mechanism 4. Accordingly, the reduction mechanism 4 appropriately decreases the rotational speed of each of the first, second and third rotating shafts 21A, 21B and 21C of the respective first, second and third rotating electrical mechanisms 2A, 2B and 2C.

According to the embodiment, a single-phase rotating electrical mechanism is used as each of the first, second and third rotating electrical mechanisms 2A, 2B and 2C. Furthermore, three of the single-phase rotating electrical mechanisms (which will be hereinafter referred to as the first, second and third single-phase rotating electrical mechanisms 2A, 2B and 2C) are connected so as to form a three-phase (i.e. in order to generate a three-phase electric current). Illustrated in FIG. 4 is a schematic configuration of one of the single-phase rotating electrical mechanisms configuring the rotating electrical mechanism 2 according to this embodiment. As illustrated in FIG. 4, the single-phase rotating electrical mechanism (2) includes the permanent magnet PM at the rotor R and the coil C at the stator S. In FIG. 4, the coil C is indicated by a chain double-dashed line as if the coil C is wound so as to exceed a diameter of the stator S. The coil C is indicated so as to exceed the diameter of the stator S in order to facilitate a winding state of the coil C. However, in practice, the coil C is wound around the stator S so as not to exceed the diameter of the stator S. The rotor R is rotated on the rotating shaft 21 in response to the attraction force and the repulsive force, which are generated between the electromagnetic force, which is generated when the coil C is electrified by the control portion 10, and the permanent magnet PM. The stator S illustrated in FIG. 4 includes an auxiliary electrode E, to which the coil C is not wound, so that a flux generated at the stator S flows smoothly in order to smoothen a torque ripple generated at the single-phase rotating electrical mechanism (2). More specifically, in this embodiment, two auxiliary electrodes E are provided at the stator S.

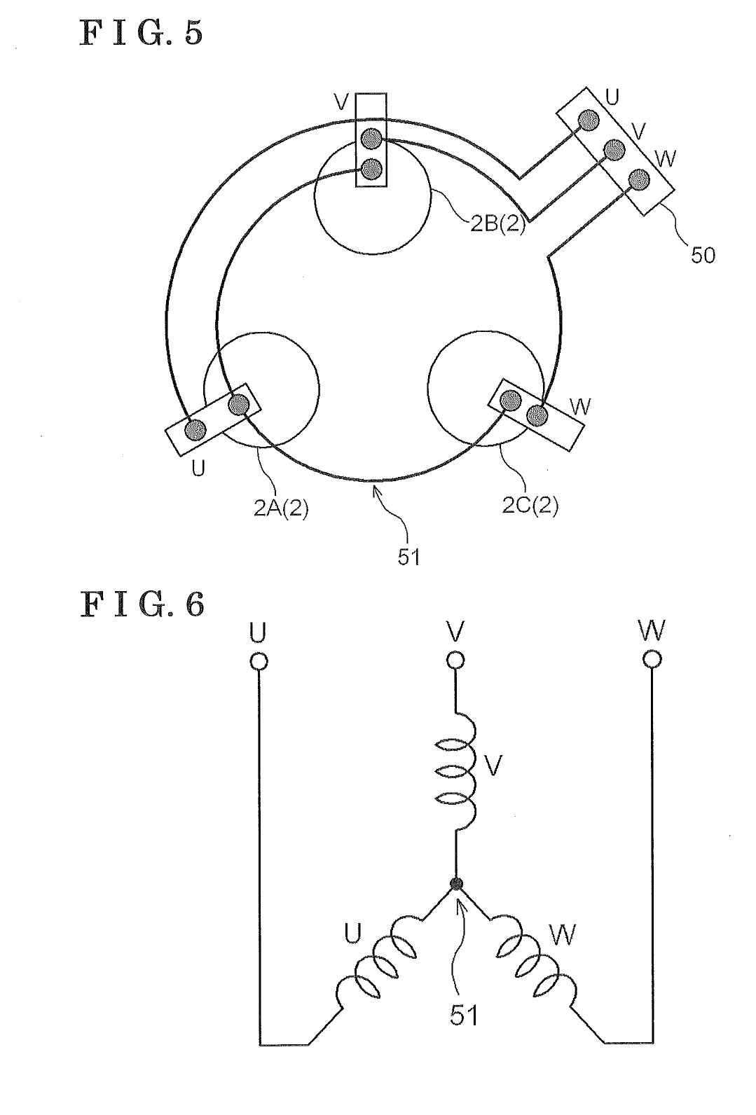

A case where the first, second and third single-phase rotating electrical mechanisms 2A, 2B and 2C are driven as a single three-phase rotating electrical mechanism will be described below with reference to FIG. 5. The first, second and third single-phase rotating electrical mechanisms 2A, 2B and 2C form a U-phase (a first phase), a V-phase (a second phase) and a W-phase (a third phase), respectively, so that the U-phase, the V-phase and the W-phase configure the three-phase. In this embodiment, the first single-phase rotating electrical mechanism 2A configures the U-phase. The second single-phase rotating electrical mechanism 2B configures the V-phase. Furthermore, the third single-phase rotating electrical mechanism 2C configures the W-phase. Additionally, the first, second and third single-phase rotating electrical mechanisms 2A, 2B and 2C are connected by means of a binding terminal in order to generate the three-phase current. Accordingly, a binding terminal (a connector) 50, which serves as a portion of the three-phase rotating electrical mechanism, is configured so that a U-phase terminal (a first phase terminal) of the biding terminal 50 is connected to one of terminals of the first single-phase rotating electrical mechanism 2A (i.e. a U-phase terminal of the first single-phase rotating electrical mechanism 2A), a V-phase terminal (a second-phase terminal) of the binding terminal 50 is connected to one of terminals of the second single-phase rotating electrical mechanisms 2B (i.e. a V-phase terminal of the second single-phase rotating electrical mechanism 2B), and a W-phase terminal (a third-phase terminal) of the binding terminal 50 is connected to one of terminals of the third single-phase rotating electrical mechanism 2C (i.e. a W-phase terminal of the third single-phase rotating electrical mechanism 2D). The other terminal of the first single-phase rotating electrical mechanism 2A, the other terminal of the second single-phase rotating electrical mechanism 2B and the other terminal of the third single-phase rotating electrical mechanism 2C are connected in series by means of a wire and the like. The first, second and third single-phase rotating electrical mechanisms 2A, 2C and 2B, which are connected as described above, form a Y-connection, as illustrated in FIG. 6. A connection (e.g. the wire and the like), which connects the other terminal of the first single-phase rotating electrical mechanism 2A, the other terminal of the second single-phase rotating electrical mechanism 2B and the other terminal of the third single-phase rotating electrical mechanism 2C in series, are commonly connected at a neutral point, which is electrically neutral, so that the connection serves as a neutral treatment connection 51.

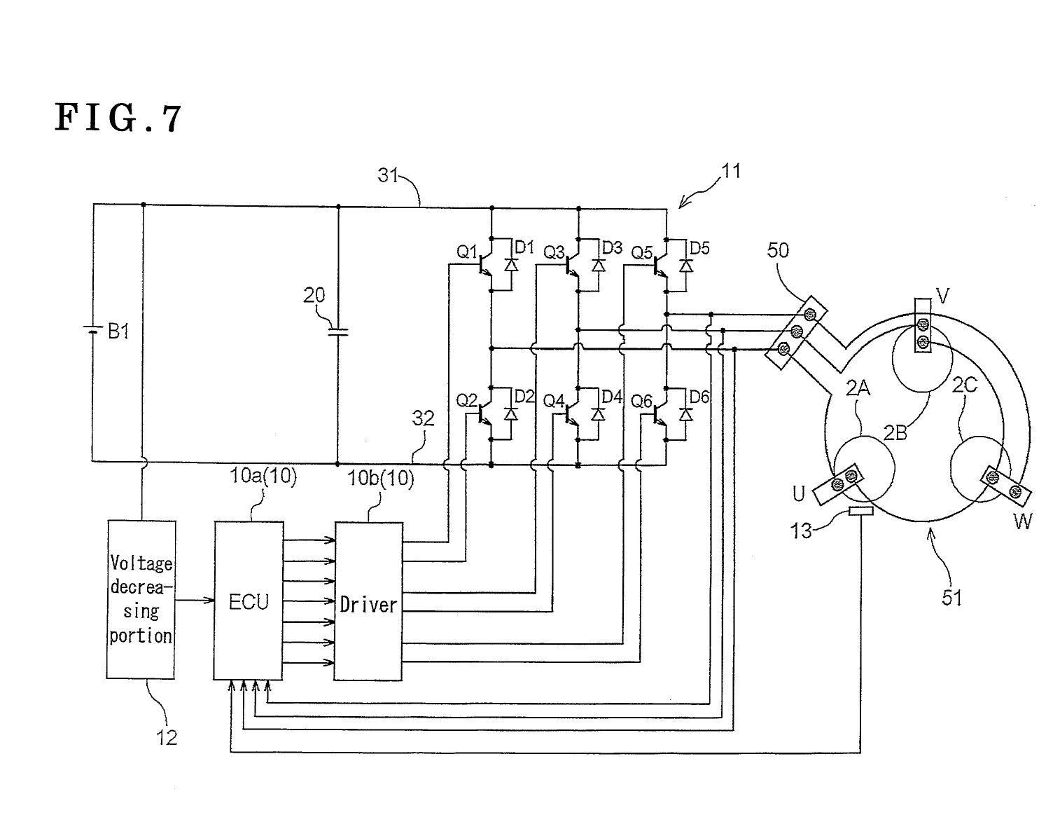

Illustrated in FIG. 7 is a diagram schematically illustrating configurations of, specifically, the control portion 10, the frequency converting portion 11 and the first, second and third single-phase rotating electrical mechanisms 2A, 2B and 2C. As described above, the first, second and third single-phase rotating electrical mechanisms 2A, 2B and 2C are connected so as to from the Y-connection, so that the first, second and third rotating electrical mechanisms 2A, 2B and 2C configure the single three-phase rotating electrical mechanism. Furthermore, the U-phase terminal of the first single-phase rotating electrical mechanism 2A, the V-phase terminal of the second single-phase rotating electrical mechanism 2B and the W-phase terminal of the third single-phase rotating electrical mechanism 2D are connected to (integrated by) the binging terminal 50. The binding terminal 50 is connected to the frequency converting portion 11.

The frequency converting portion 11 converts the direct current voltage, which is outputted by the battery B1, into the alternating current voltage. As illustrated in FIG. 7, the frequency converting portion 11 is configured with six transistors. More specifically, the frequency converting portion 11 is configured with high-side transistors Q1, Q3 and Q5, whose collector terminals are connected to a positive electrode of the battery B1, and low-side transistors Q2, Q4, Q6, whose emitter terminals are connected to a negative electrode of the battery B1. For example, in a case where only the high-side transistor Q1 and the low-side transistor Q4 are simultaneously turned on, the electric current flows from the battery B1 to a second power line 32 via a first power line 31, the high-side transistor Q1, the first single-phase rotating electrical mechanism 2A, the second single-phase rotating electrical mechanism 2B and the low-side transistor Q4. On the other hand, in a case where only the high-side transistor Q3 and the low-side transistor Q2 are simultaneously turned on, the electric current flows from the battery B1 to the second power line 32 via the first power line 31, the high-side transistor Q3, the second single-phase rotating electrical mechanism 2B, the first single-phase rotating electrical mechanism 2A and the low-side transistor Q2.

As described above, a direction (i.e. a transmission path) of the electric current flowing between the first single-phase rotating electrical mechanism 2A and the second single phase rotating electrical mechanism 2B differs between the case where only the high-side transistor Q1 and the low-side transistor Q4 are turned on and the case where only the high-side transistor Q3 and the low-side transistor Q2 are turned on. Therefore, the electromagnetic force is generated at each coil C in response to the direction of the electric current flowing through each rotating electrical mechanism, so that the attraction force and the repulsive force are generated between the electromagnetic force and the permanent magnet PM of the rotor R of each rotating electrical mechanism. Accordingly, by sequentially turning on pairs of the high-side transistor and the low-side transistor (i.e. each combination of one of the high-side transistors Q1, Q3 and Q5 and one of the low-side transistors Q2, Q4 and Q6), the rotor R generates the rotational force. In other words, by sequentially turning on the pairs of the high-side transistors and the low-side transistors, the first, second and third single-phase rotating electrical mechanisms 2A, 2B and 2C are rotatably driven.

Each of the transistors Q1, Q2, Q3, Q4, Q5 and Q6 is provided with each of diodes D1, D2, D3, D4, D5 and D6 so that a cathode terminal of each of the diodes D1, D2, D3, D4, D5 and D6 is connected to the collector terminal of each of the transistors Q1, Q2, Q3, Q4, Q5 and Q6 and so that an anode terminal of each of the diodes D1, D2, D3, D4, D5 and D6 is connected to the emitter terminal of each of the transistors Q1, Q2, Q3, Q4, Q5 and Q6. Generally, energy is stored at each coil C while each coil C is electrified. Therefore, a negative impact may be generated to the components surrounding the first, second and third rotating electrical mechanisms 2A, 2B and 2C because of an inverse electromotive force, which is generated due to the energy stored at each coil C when the electrification of the coil C is stopped. Hence, in order to prevent the surrounding components from being influenced by the inverse electromotive force, the diodes transistors D1, D2, D3, D4, D5 and D6 are provided at the corresponding transistors 01, Q2, Q3, Q4, Q5 and Q6. Accordingly, the driving device 100 of the embodiment is configured so that the single frequency converting portion 11 drives plural single-phase rotating electrical mechanisms (i.e. the first, second and third single-phase rotating electrical mechanisms 2A, 2B and 2C) as one three-phase rotating electrical mechanism.

A series of control of each of the transistors Q1, Q2, Q3, Q4, Q5 and Q6 is executed by the control portion 10. The control portion 10 is configured with an electronic control unit 10a (which will be hereinafter referred to as an ECU 10a) and a driver 10b. The ECU 10a executes a pulse width modulation control (which will be hereinafter referred to as a PWM control) in order to actuate each of the transistors Q1, Q2, Q3, Q4, Q5 and Q6. As the known PWM control is used, the detailed explanation of the PWM control is omitted here. A rotational angle detecting portion 13 is provided in the vicinity of the first single-phase rotating electrical mechanism 2A in order to detect a rotational angle of the rotor R of the first single-phase rotating electrical mechanism 2A. The first, second and third rotating electrical mechanisms 2A, 2B and 2C are arranged so that the U-phase, V-phase and W-phase are out of phase with each other by 120 degrees. Therefore, the rotational angle detecting portion 13 does not need to be provided at each of the first, second and third single-phase rotating electrical mechanisms 2A, 2B and 2C. Accordingly, in this embodiment, the rotational angle detecting portion 13 is provided only in the vicinity of, for example, the first single-phase rotating electrical mechanism 2A. A detection signal outputted from the rotational angle detecting portion 13 is transmitted to the ECU 10a.

The ECU 10a monitors the detection signal outputted from the rotational angle detecting portion 13 and the electric current flowing between the frequency converting portion 11 and the coil C of each of the first, second and third single-phase rotating electrical mechanisms 2A, 2B and 2C. The ECU 10a may be modified so as to monitor the voltage applied to each of the first, second and third single-phase rotating electrical mechanisms 2A, 2B and 2C, instead of monitoring the electric current, depending on a driving system of the ECU 10a.

The ECU 10a is configured with, for example, a microcomputer, which is actuated by a low voltage such as 5V and the like. Therefore, a drive function of the ECU 10a for turning on each of the transistors Q1, Q2, Q3, Q4, Q5 and Q6 may become insufficient depending on the electric current flowing though each of the transistors Q1, Q2, Q3, Q4, Q5 and Q6 and, an electric characteristic of each of the transistors Q1, Q2, Q3, Q4, Q5 and Q6 or the like. Accordingly, the driver 10b is provided between the ECU 10a and the frequency converting portion 11 in order to enhance the drive function of a pulse width modulation signal (which will be hereinafter referred to as a PWM signal), which is outputted by the ECU 10a. The driver 10b may be configured with a driver IC, a push-pull circuit configured with a transistor, or the like.

As described above, the battery B1 outputs the voltage, which is, for example, equal to or grater than 270 V. On the other hand, the ECU 10a is configured with the microcomputer, which is actuated by the low voltage such as, for example, 5V and the like. Therefore, when the output voltage of the battery B1 is directly applied to the ECU 10a, the ECU 10a may electrically break down. Hence, the output voltage of the battery B1 is decreased to a predetermined voltage (e.g. 5V and the like), so that the decreased voltage is applied to the ECU 10a in order to avoid the occurrence of the electrically break down of the ECU 10a. Furthermore, a capacitor 20 is provided at a former stage of the frequency converting portion 11 relative to the transistors Q1, Q2, Q3, Q4, Q5 and Q6 in the electric current flow. The capacitor 20 removes a ripple component, which is superimposed on the output of the battery B1.

In the case where each of the first, second and third single-phase rotating electrical mechanisms 2A, 2B and 2C is rotated in response to the electric power supplied thereto from the battery B1, each of the first, second and third single-phase rotating electrical mechanisms 2A, 2B and 2C functions as the motor. On the other hand, in the case where each of the first, second and third single-phase rotating electrical mechanisms 2A, 2B and 2C is rotated in response to the output of the engine 1, each of the first, second and third single-phase rotating electrical mechanisms 2A, 2B and 2C functions as the generator. In the case where each of the first, second and third single-phase rotating electrical mechanisms 2A, 2B and 2C functions as the generator, the diodes D1, D2, D3, D4, D5 and D6 configure a bridge rectifier circuit together with the capacitor 20. In a case where, for example, the energy, which is generated when the electric current flows from the coil C of the first single-phase rotating electrical mechanism 2A to the coil C of the second single-phase rotating electrical mechanism 2B and which is stored at each coil C, is extracted when each of the first, second and third single-phase rotating electrical mechanisms 2A, 2B and 2C functions as the generator, the electric current flows from the coil C of the first single-phase rotating electrical mechanism 2A to the coil C of the second single-phase rotating electrical mechanism 2B via the diode D1, the capacitor 20 and the diode D4. Accordingly, the electric energy is stored at the capacitor 20 in response to the electric current flowing from the coil C of the first single-phase rotating electrical mechanism 2A to the coil C of the second single-phase rotating electrical mechanism 2B. Additionally, the electric energy is transmitted from the coil C of the second single-phase rotating electrical mechanism 2B and the coil C of the third single-phase rotating electrical mechanism 2C to the capacitor 20 in order to store the electric energy thereat in response to the rotation of each of the first, second and third single-phase rotating electrical mechanisms 2A, 2B and 2C. The electric energy is stored at the battery B1 (i.e. the electric energy is regenerated).

According to the driving device 100, which is configured as described above, the rotational force of the rotating electrical mechanism 2, which rotates at the high speed, is transmittable to the input shaft A2 of the transmission apparatus 5. Furthermore, because the rotating electrical mechanism 2 is configured with plural rotating electrical mechanisms (2), a required output is dividedly generated by plural rotating electrical mechanisms (2), in other words, because each of plural rotating electrical mechanisms (2) generates the output force so that the total output reaches the required output force, a size of each of plural rotating electrical mechanisms (2) does not need to be increased in order to rotate the driving device 2 at the high speed (i.e. in order to increase the output of the rotating electrical mechanism). Accordingly, even in a case where a space for providing the rotating electrical mechanism 2 is limited depending on combinations of one of various engines and one of various transmission apparatuses, the rotating electrical mechanism 2 is easily arranged. In other words, the rotating electrical mechanism 2 may be used for any combination of one of the various engines and one of the various transmission apparatuses. As a result, the driving device 100 for the vehicle is achieved with relatively low manufacturing costs.

### Other Embodiments

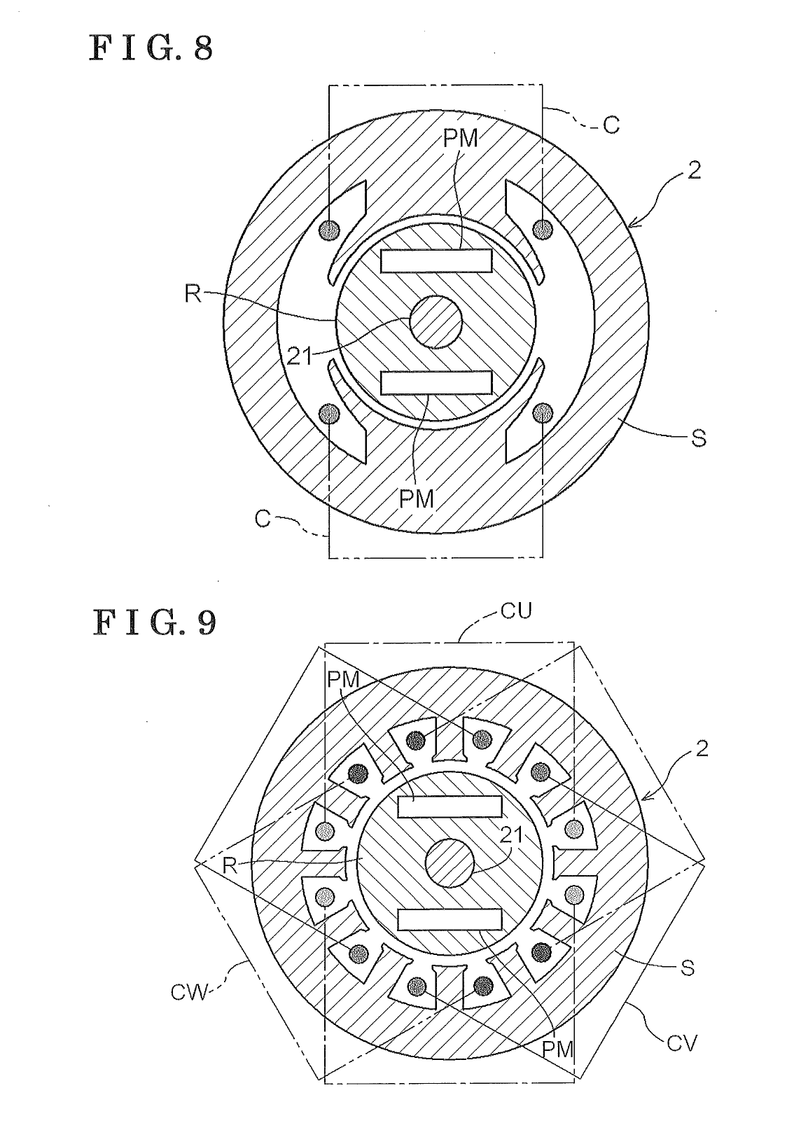

In the above-described embodiment, the stator S of the single-phase rotating electrical mechanism 2 includes the auxiliary electrodes E at the area where the coil C is not wound in order to facilitate a flow of the flux generated at the stator S, so that the torque ripple is smoothened. However, the present invention is not limited to the above-described configuration. For example, as illustrated in FIG. 8, the single-phase rotating electrical mechanism 2 may be modified so as not to include the auxiliary electrodes E. In this case, a number of materials used for the stator S is reduced, which may result in reducing the manufacturing costs. Furthermore, in the case where the stator S does not include the auxiliary electrodes E, because a shape of the single-phase rotating electrical mechanism 2 is simplified, the stator S may be easily manufactured.

In the above-described embodiment, the rotating electrical mechanism 2 of the driving device 100 is configured with plural rotating electrical mechanisms (2A, 2B and 2C). More specifically, in the above-described embodiment, the rotating electrical mechanism 2 of the driving device 100 is configured with the first, second and third single-phase rotating electrical mechanisms 2A, 2B and 2C, which are connected so as to generate the three phase electric power. However, the present invention is not limited to the above-described configuration. For example, the rotating electrical mechanism 2 may be configured with plural three-phase rotating electrical mechanisms (i.e. first, second and third three-phase rotating electrical mechanisms 2A, 2B and 2C). Illustrated in FIG. 9 is a schematic configuration of one of the three-phase rotating electrical mechanisms 2A, 2B and 2C. As illustrated in FIG. 9, a U-phase coil CU, a V-phase coil CV and a W-phase coil CW are wound at a stator S of the three-phase rotating electrical mechanism (2). According to this configuration, a rotor R of the three-phase rotating electrical mechanism (2) is rotated on a rotational axis of the rotor R in response to an attraction force and a repulsive force generated between a permanent magnet PM and an electromagnetic force, which is generated when each of the U-phase coil CU, the V-phase coil CV and the W-phase coil CW is electrified by the control portion 10.

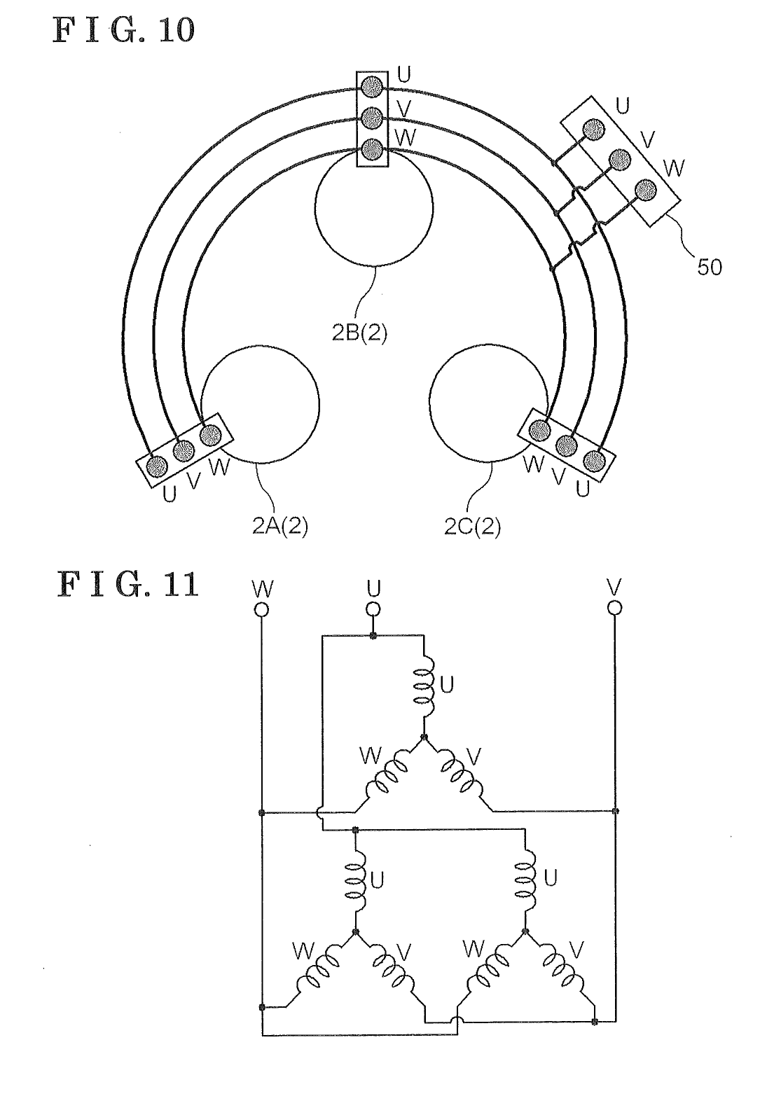

For example, it may be preferable to connect the first, second and third three-phase rotating electrical mechanisms 2A, 2B and 2C so that connecting terminals of each of the first, second and third three-phase rotating electrical mechanisms 2A, 2B and 2C are connected to the corresponding terminals in parallel. More specifically, as illustrated in FIG. 10, the first, second and third three-phase rotating electrical mechanisms 2A, 2B and 2C are connected so that the U-phase terminals of the respective first, second and third thee-phase rotating electrical mechanisms 2A, 2B and 2C are connected in parallel. Furthermore, the U-phase terminals of the respective first, second and third three-phase rotating electrical mechanisms 2A, 2B and 2C are connected to (integrated at) a U-phase terminal of the binding terminal 50. V-phase terminals of the respective first, second and third three-phase rotating electrical mechanisms 2A, 2B and 2C are connected in parallel. Furthermore, the V-phase terminals of the respective first, second and third three-phase rotating electrical mechanisms 2A, 2B and 2C are connected to (integrated at) a V-phase terminal of the binding terminal 50. W-phase terminals of the respective first, second and third three-phase rotating electrical mechanisms 2A, 2B and 2C are connected in parallel. Furthermore, the W-phase terminals of the respective first, second and third three-phase rotating electrical mechanisms 2A, 2B and 2C are connected to (integrated at) a W-phase terminal of the binding terminal 50. Illustrated in FIG. 11 is a configuration example of the first, second and third three-phase rotating electrical mechanisms 2A, 2B and 2C, which are connected as mentioned above. According to the above-described connecting example of the first, second and third three-phase rotating electrical mechanisms 2A, 2B and 2C, only three connecting terminals need to be provided at each of the first, second and third three-phase rotating electrical mechanisms 2A, 2B and 2C. More specifically, each of the first, second and third rotating electrical mechanisms 2A, 2B and 2C is configured so as to include only three connecting terminals, i.e. the U-phase terminal, the V-phase terminal and the W-phase terminal. Accordingly, expense for components used at the rotating electrical mechanism 2 may be reduced.

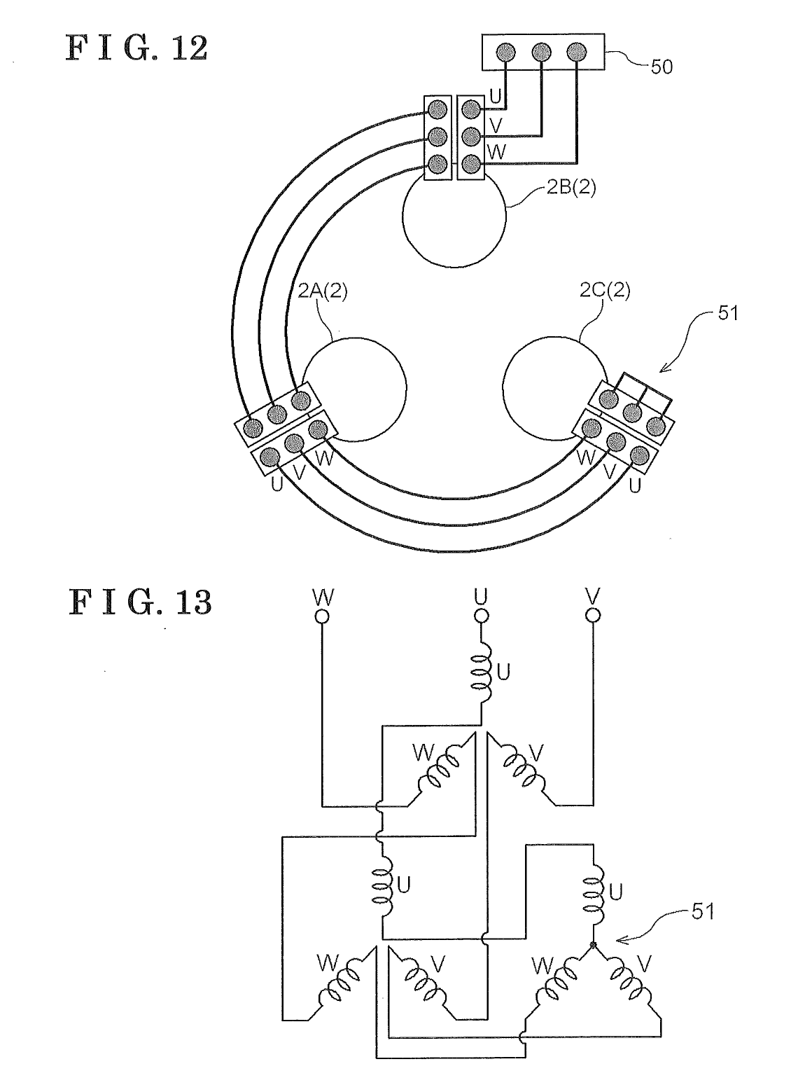

Alternatively, the first, second and third three-phase rotating electrical mechanisms 2A, 2B and 2C may be connected so that the connecting terminals of each of the first, second and third three-phase rotating electrical mechanisms 2A, 2B and 2C are connected to the corresponding terminals in series. More specifically, as illustrated in FIG. 12, the U-phase terminals of the respective first, second and third three-phase rotating electrical mechanisms 2A, 2B and 2C are connected in series. Furthermore, the U-phase terminals of the respective first, second and third three-phase rotating electrical mechanisms 2A, 2B and 2C are connected to (integrated at) the U-phase terminal of the binding terminal 50. The V-phase terminals of the respective first, second and third three-phase rotating electrical mechanisms 2A, 2B and 2C are connected in series. Furthermore, the V-phase terminals of the respective first, second and third three-phase rotating electrical mechanisms 2A, 2B and 2C are connected to (integrated at) the V-phase terminal of the binding terminal 50. The W-phase terminals of the respective first, second and third three-phase rotating electrical mechanisms 2A, 2B and 2C are connected in series. Furthermore, the W-phase terminals of the respective first, second and third three-phase rotating electrical mechanisms 2A, 2B and 2C are connected to (integrated at) the W-phase terminal of the binding terminal 50. Additionally, the U-phase terminal, the V-phase terminal and the W-phase terminal of the third three-phase rotating electrical mechanism 2C, which are not connected to the binding terminal 50, are commonly connected to a neutral portion, which is electrically neutral, by means of a wire and the like, which serves as the neutral treatment connection 51. Illustrated in FIG. 13 is a configuration example of the first, second and third three-phase rotating electrical mechanisms 2A, 2B and 2C, which are connected as mentioned above. According to the above-described connecting example of the first, second and third three-phase rotating electrical mechanisms 2A, 2B and 2C, the electric current is equally supplied to the coils C of the respective first, second and third three-phase rotating electrical mechanisms 2A, 2B and 2C. Accordingly, even in a case where impedance generated at the coils C of the respective first, second and third three-phase rotating electrical mechanisms 2A, 2B and 2C is uneven because of differences in individual properties of the first, second and third three-phase rotating electrical mechanisms 2A, 2B and 2C, each of the first, second and third three-phase rotating electrical mechanisms 2A, 2B and 2C are properly and rotatably controlled.

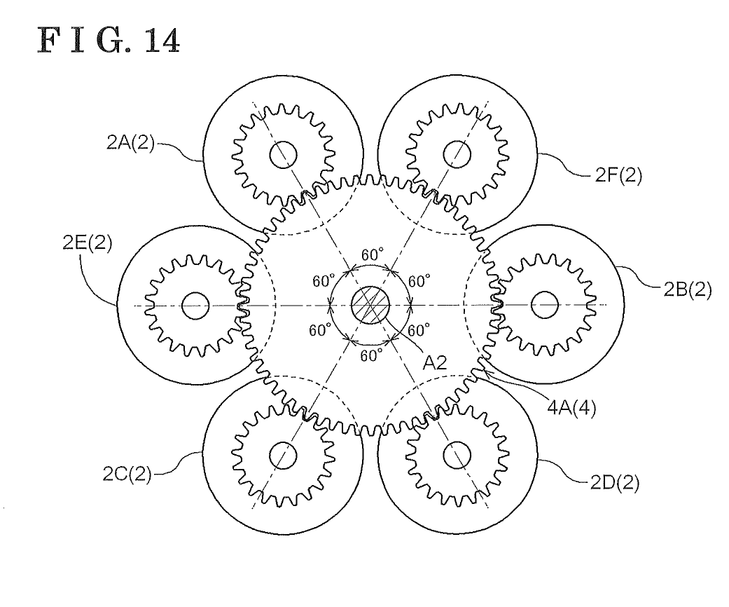

According to the above-described embodiment, the rotating electrical mechanism 2 is configured with three rotating electrical mechanisms (i.e. the first, second and third rotating electrical mechanisms 2A, 2B and 2C). However, the present invention is not limited to the above-described configuration. For example, the rotating electrical mechanism 2 may be modified so as to include six rotating electrical mechanisms 2A, 2B, 2C, 2D, 2F and 2D, as illustrated in FIG. 14. In this case, a set of the U-phase, the V-phase and the W-phase may be formed by the rotating electrical mechanisms 2A, 2B and 2C and another set of the U-phase, the V-phase and the W-phase may be formed by the rotating electrical mechanisms 2D, 2E and 2F. Furthermore, in this case, the rotating electrical mechanisms 2A, 2B, 2C, 2D, 2F and 2E may be arranged at regular intervals, as illustrated in FIG. 14. In other words, the rotating electrical mechanisms 2A, 2B, 2C, 2D, 2F and 2E may be arranged so as to form an angle of 60 degrees between the neighboring rotating electrical mechanisms with respect to the input shaft A2 of the transmission apparatus 5.

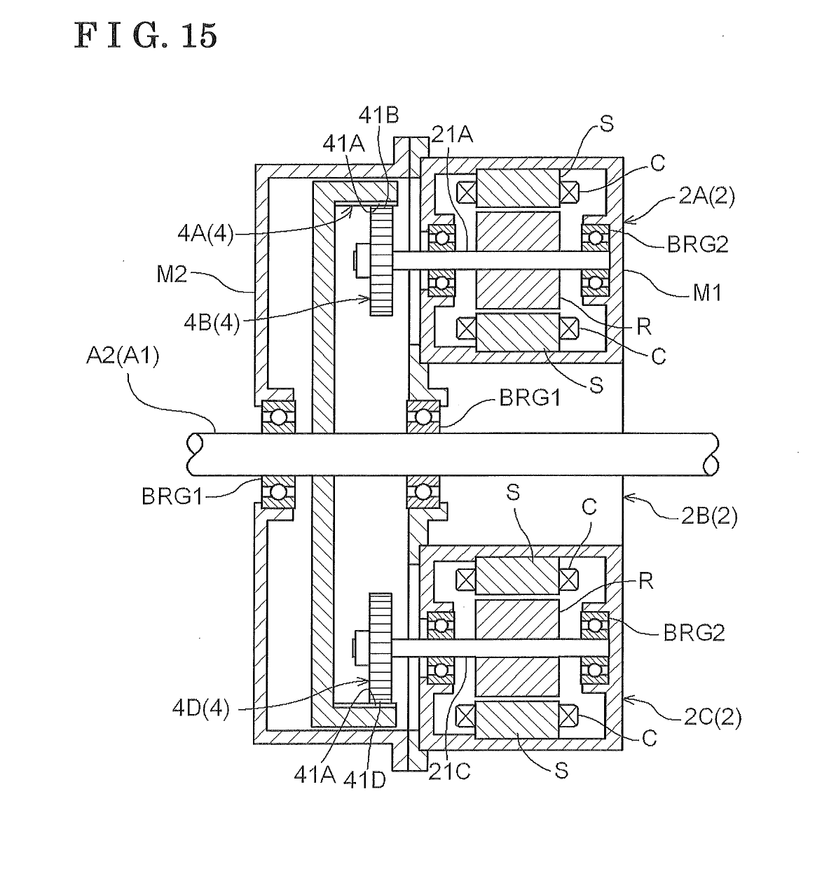

According to the above-described embodiment, the reduction mechanism 4 is configured so that the first gear 4A and the second gear 4B are arranged in line (see FIG. 2). More specifically, the first gear 4A and the second gear 4B are engaged with each other so as to be aligned in a direction orthogonal to the axial direction of the input shaft 4A. However, the present invention is not limited to the above-described configuration. For example, as illustrated in FIG. 15, the first gear 4A may be modified so as to serve as an internal gear (e.g. an annular gear). Even in this case, the rotational speed of the rotating electrical mechanism 2 is properly reduced, so that the reduced rotational speed of the rotating electrical mechanism 2 is transmitted to the input shaft A2 of the transmission apparatus 5.

According to the above-described embodiment, the frequency converting portion 11 includes the transistors Q1, Q2, Q3, Q4, Q5 and Q6. A bipolar transistor, a metal-oxide-semiconductor field-effect transistor (MOS-FET), an insulated gate bipolar transistor (IGBT) or the like may be used as each of the transistors Q1, Q2, Q3, Q4, Q5 and Q6.

According to the above-described embodiment, the single-phase rotating electrical mechanism or the three-phase rotating electrical mechanism is used as the rotating electrical mechanism 2. Either a synchronous rotating electrical mechanism or an inductive rotating electrical mechanism may be used as the rotating electrical mechanism 2. In any case where the synchronous rotating electrical mechanism is used as the rotating electrical mechanism 2 or the inductive rotating electrical mechanism is used as the rotating electrical mechanism 2, the above-described driving device 100 for the vehicle is achievable. Specifically, in a case where a single-phase inductive rotating electrical mechanism is used as the rotating electrical mechanism 2, a shading coil may be provided at the stator S of the rotating electrical mechanism 2 in order to delay a generation of magnetic field, which is to be generated at the coil C.

Additionally, the synchronous rotating electrical mechanism and the inductive rotating electrical mechanism may be combined to configure the rotating electrical mechanism 2. In this case, the rotating electrical mechanism 2 may be configured with plural rotating electrical mechanisms, which are connected in series. Furthermore, in the case where the synchronous rotating electrical mechanism and the inductive rotating electrical mechanism are combined to configure the rotating electrical mechanism 2, the rotational angle detecting portion 13 for detecting the rotational angle of the rotor R may be configured so as to detect only the rotational angle of the rotor R of the synchronous rotating electrical mechanism. On the other hand, the rotational angle of the rotor R of the inductive rotating electrical mechanism is not always necessarily be detected. However, the rotational angle of the rotor R of the inductive rotating electrical mechanism may be detected, in the case where the inductive rotating electrical mechanism is modified so as to enhance a function thereof.

Furthermore, rotating electrical mechanisms having different performances (functions, properties) may be combined to configure the rotating electrical mechanism 2. In this case, the frequency converting portion 11 may be provided at each rotating electrical mechanism. Accordingly, because the rotating electrical mechanism 2 includes the rotating electrical mechanisms having different performances (functions, properties), the rotating electrical mechanisms may complement mutual performances (functions, properties). As a result, the function (performance) of the driving device 100 for the vehicle may be enhanced.

According to the above-described embodiment, the rotating electrical mechanism 2 is rotatably controlled in response to the electric power supplied thereto from the battery B1. However, the present invention is not limited to the above-described configuration. For example, the driving device 100 may be modified so that a voltage converting portion is provided between the battery B1 and the frequency converting portion 11 in order to increase the output voltage of the battery B1. The DC/DC converter (i.e. a voltage increase chopper circuit) having a voltage increasing function may be used as the voltage converting portion. The DC/DC converter includes a coil, a transistor, a diode and a capacitor. Furthermore, the voltage converting portion may be modified so that a voltage of the electric power generated by the rotating electrical mechanism 2 is decreased to a voltage suitable to be stored at the battery B1. In this case, a DC/DC converter (i.e. a voltage decrease chopper circuit) having a voltage decreasing function may be configured at the voltage converting portion. The DC/DC converter (i.e. the voltage decrease chopper circuit) includes a coil, a transistor, a diode and a capacitor. Additionally, a transformer may be used for the voltage increase chopper circuit and the voltage decrease chopper circuit.

According to the above-described embodiment, the reduction mechanism 4 is configured so that the first gear 4A, which is provided at the input shaft A2 of the transmission apparatus 5, is engaged with each of the second gears 4B, 4C and 4D, which is provided at each of the first, second and third rotational shafts 21A, 21B and 21C of each of the first, second and third rotating electrical mechanisms 2A, 2B and 2C. Furthermore, the number of teeth formed at the first gear 4A is set to be greater than the number of teeth formed at each of the second gears 4B, 4C and 4D. However, the present invention is not limited to the above-described configuration. For example, the reduction mechanism 4 may be modified so that a gear is provided between the first gear 4A on the one hand and each of the second gears 4B, 4C and 4D on the other, so that the reduction mechanism 4 is configured with three or more gears. In this case, the number of the teeth formed at the first gear 4A may be set to be smaller than the number of the teeth formed at each of the second gears 4B, 4C and 4D depending on the configuration of the other gears provided between the first gear 4A on the one hand and the second gears 4B, 4C and 4D on the other, respectively.

According to the above-described embodiment, the rotating electrical mechanism 2 includes plural rotating electrical mechanisms (2), so that the plural rotating electrical mechanisms (2) are arranged on the concentric circle having the axis of the input shaft A2 of the transmission apparatus 5 as the center point. However, the present invention is not limited to the above-described configuration. For example, the rotating electrical mechanism 2 may be configured with the single rotating electrical mechanism (2). Furthermore, even in the case where the rotating electrical mechanism 2 includes plural rotating electrical mechanisms (2), the plural rotating electrical mechanisms (2) may be arranged so as not to be on the concentric circle having the axis of the input shaft A2 of the transmission apparatus 5 as the center point.

According to the above-described embodiment, the frequency converting portion 11 for converting the direct current voltage into the alternating current voltage is provided at the driving device 100 for the vehicle, so that plural rotating electrical mechanisms (2) are controlled by the single frequency converting portion 11. However, the present invention is not limited to the above-described configuration. For example, plural frequency converting portions 11 may be provided at the driving device 100 for the vehicle, so that plural rotating electrical mechanisms (2) are controlled by respective plural frequency converting portions 11.

According to the above-described embodiment, the rotating electrical mechanism 2 is configured with plural rotating electrical mechanisms, which are arranged at regular intervals in the circumferential direction of the input shaft A2 of the transmission apparatus 5. However, the present invention is not limited to the above-described configuration. For example, the rotating electrical mechanism 2 may be configured with plural rotating electrical mechanisms, which are arranged not at regular intervals.

According to the above-described embodiment, the driving device 100 is configured so that the connecting clutch 3 is disposed between the engine 1 and the rotating electrical mechanism 2. However, the present invention is not limited to the above-described configuration. For example, the driving device 100 may be modified so as not to include the connecting clutch 3. Alternatively, the driving device 100 may be modified so as to include a damper between the connecting clutch 3 and the engine 1.

Accordingly, because the reduction mechanism 4 is disposed between the engine 1 and the rotating electrical mechanism 2 on the one hand and the transmission apparatus 5 on the other, the rotational speed of the rotating electrical mechanism 2 does not need to be decreased to a rotational speed acceptable to be inputted to the input shaft A2 of the transmission apparatus 5. As a result, the rotating electrical mechanism 2 is rotatable at the high speed. Furthermore, in the case where the rotational driving force generated at the engine 1 is transmitted to the rotating electrical mechanism 2, the rotational speed of the engine 1 is changed to a high speed by the reduction mechanism 4, so that the high rotational speed is transmitted to the rotating shaft 21 of the rotating electrical mechanism 2. Accordingly, the rotating electrical mechanism 2 is effectively actuated. Furthermore, the driving device 100 of the embodiment may be modified so that the rotating electrical mechanism 2 generates various levels of the output force suitable to a combination of engine and transmission apparatus by modifying the reduction mechanism 4. In other words, the driving device 100 of the embodiment is adaptable to various combinations of engines and transmission apparatuses, because the output force required to be generated is easily achieved by modifying the reduction mechanism 4. More specifically, the output of the rotating electrical mechanism 2 is easily changed to any level of output by modifying the reduction mechanism 4. Therefore, the driving device 100 for the vehicle having the rotating electrical mechanism 2, which is modifiable so as to be suitable to various combinations of the engines and the transmission apparatuses, is achieved. Accordingly, the rotating electrical mechanism 2 may be used to various driving devices for vehicle. As a result, the driving device 100 for the vehicle is manufactured at relatively low costs.

According to the embodiments, the reduction mechanism 4 includes the first gear 4A, which is provided on the input shaft A2 of the transmission apparatus 5, and the second gears 4B, 4C and 4D, which are provided on the first, second and third rotating shaft 21A, 21B and 21C of the respective first, second and third rotating electrical mechanisms 2A, 2B and 2C. The first gear 4A is engaged with each of the second gears 4B, 4C and 4D. Furthermore, the number of teeth formed at the first gear 4A is set to be greater than the number of teeth formed at each of the second gears 4B, 4C and 4D.

Accordingly, in the case where the rotational driving force generated by the rotating electrical mechanism 2 is transmitted to the transmission apparatus 5, the rotational speed of the rotating electrical mechanism 2 is appropriately decreased by the reduction mechanism 4, so that the decreased rotational speed of the rotating electrical mechanism 2 is transmitted to the transmission apparatus 5. Furthermore, in the case where the rotational driving force generated by the engine 1 is transmitted to the rotating electrical mechanism 2, the rotational speed of the engine 1 is changed to the high speed via the reduction mechanism 4, so that the increased rotational speed of the engine 1 is transmitted to the rotating electrical mechanism 2.

According to the embodiments, the rotating electrical mechanism 2 is configured with plural rotating electrical mechanisms (2A, 2B, 2C), so that plural rotating electrical mechanisms (2A, 2B, 2C) are arranged on the concentric circle having the axis of the input shaft A2 of the transmission apparatus 5 as the center point.

Accordingly, the input shaft A2 of the transmission apparatus 5 is rotated by plural rotating electrical mechanisms (2). Therefore, the force (the power) necessary to be generated is dividedly and separately outputted by plural rotating electrical mechanisms (2). In other words, each of plural rotating electrical mechanisms (2) generates the output force (the power) so that the total output force (the power) reaches a level of the force (the power) required to be generated for the single rotating electrical mechanism 2. Accordingly, downsize of the driving device 100 for the vehicle is achievable. Furthermore, the driving device 2 may be modified so as to include any desired number of rotating electrical mechanisms (2) in response to the output force required to be generated by the rotating electrical mechanism 2. Accordingly, the rotating electrical mechanism 2 (i.e. a single type of the rotating electrical mechanism 2) may be used for various types of the driving device 100. As a result, the driving device 100 for the vehicle is achievable with relatively low manufacturing costs.

According to the embodiments, the driving device 100 further includes the frequency converting portion 11 for converting the direct current voltage into the alternating current voltage. The rotating electrical mechanism 2 configured with plural rotating electrical mechanisms (2A, 2B, 2C) is controlled by the single frequency converting portion 11.

Accordingly, because the driving device 100 for the vehicle does not need to include plural frequency converting portions 11, the driving device 100 for the vehicle is achievable at relatively low manufacturing costs. In the case where the driving device 100 for the vehicle includes plural frequency converting portions 11, the rotating electrical mechanisms (2) may not be controlled at the same level because of variations in characteristics of plural frequency converting portions 11. However, according to the driving device 100 of the embodiment, because the single frequency converting portion 11 is provided at the driving device 100, plural rotating electrical mechanisms (2) may be controlled at the same level (the same degree). Accordingly, the rotating electrical mechanism 2 is properly controlled.

According to the embodiments, the rotating electrical mechanism 2 is configured with three single-phase rotating electrical mechanisms (2A, 2B, 2C), which are connected so as to generate the three-phase electric current.

Accordingly, because three of the single-phase rotating electrical mechanisms (2) are used, the coil C is wound around a single magnetic pole of each of the three single-phase rotating electrical mechanisms, while an effective opening angle of the coil C, which forms a phase, is set to be substantially the same level as an effective opening angle of each of the coils C, each of which forms U-phase, V-phase and W-phase, of the three-phase rotating electrical mechanism. Furthermore, in a case where a imbedded magnet-type synchronous motor, which specifically uses a permanent magnetic torque and a reluctance torque, is adapted, the rotating electrical mechanism (2) generating the reluctance torque more than the permanent magnetic torque, when comparing to the three-phase rotating electrical mechanism at which the coil C is concentratively wound around each single magnetic pole, is achieved. Accordingly, the overall size of the rotating electrical mechanism (2) may be reduced.

According to the embodiments, each of the first, second and third rotating electrical mechanisms 2A, 2B and 2C is a three-phase rotating electrical mechanism, so that the U-phase terminals of the first, second and third three-phase rotating electrical mechanisms 2A, 2B and 2C are connected in parallel or in series, the V-phase terminals of the first, second and third three-phase rotating electrical mechanisms 2A, 2B and 2C are connected in parallel or in series, and the W-phase terminals of the first, second and third three-phase rotating electrical mechanisms 2A, 2B and 2C are connected in parallel or in series.

Accordingly, less torque ripple is likely to be generated. Therefore, the rotating electrical mechanism 2 is smoothly actuated even in a case where the rotating electrical mechanism 2 has just been actuated (i.e. an initial operation state of the rotating electrical mechanism 2) or in a case where the rotating electrical mechanism 2 is stably driven.

According to the embodiments, plural rotating electrical mechanisms (2A, 2B, 2C) are arranged at regular intervals in the circumferential direction of the input shaft A2 of the transmission apparatus 5.

Accordingly, because a load applied to the input shaft A2 of the transmission apparatus 5 by plural rotating electrical mechanisms (2) (i.e. a force generated in the radial direction when the torque is transmitted to the input shaft 2A, because of the engagement between the first gear 4A of the input shaft 2A on the one hand and the second gears 4B, 4C and 4D of the respective first, second and third rotating electrical mechanisms 2A, 2B and 2C on the other) is equally dispersed in the circumferential direction of the input shaft 2A. Accordingly, deterioration of the BRG1 bearing and the like, which is provided at the input shaft 2A of the transmission apparatus 5 may be avoided.

According to the embodiment, either the single-phase rotating electrical mechanism or the three-phase rotating electrical mechanism is used as each of plural rotating electrical mechanisms (2A, 2B, 2C).

According to the embodiment, plural the rotating electrical mechanisms (2A, 2B, 2C) are configured with the synchronous rotating electrical mechanism and the inductive rotating electrical mechanism.

According to the embodiment, the synchronous rotating electrical mechanism and the inductive rotating electrical mechanism are connected in series.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A driving device for a vehicle comprising:
an engine outputting a rotational driving force for driving the vehicle;
a transmission apparatus having an input shaft connectable to an output shaft of the engine, changing a rotational speed of the input shaft of the transmission apparatus and transmitting the changed rotational speed to an output member;
a rotating electrical mechanism having a rotating shaft, which has an axis that differs from an axis of the input shaft of the transmission apparatus; and
a reduction mechanism reducing a rotational speed of the rotating shaft of the rotating electrical mechanism and transmitting the reduced rotational speed to the input shaft of the transmission apparatus.

2. The driving device for the vehicle according to claim 1, wherein the reduction mechanism includes a first gear, which is provided on the input shaft of the transmission apparatus, and a second gear, which is provided on the rotating shaft of the rotating electrical mechanism, the first gear is engaged with the second gear, and a number of teeth formed at the first gear is set to be greater than a number of teeth formed at the second gear.

3. The driving device for the vehicle according to claim 1, wherein the rotating electrical mechanism includes a plurality of rotating electrical mechanisms and the plurality of the rotating electrical mechanisms are arranged on a concentric circle having the axis of the input shaft of the transmission apparatus as a center point.

4. The driving device for the vehicle according to claim 3 further comprising a frequency converting portion for converting a direct current voltage into an alternating current voltage, wherein the plurality of the rotating electrical mechanisms are controlled by the single frequency converting portion.

5. The driving device for the vehicle according to claim 3, wherein the rotating electrical mechanism includes three single-phase rotating electrical mechanisms, which are connected so as to generate a three-phase electric current.

6. The driving device for the vehicle according to claim 3, wherein each of the plurality of the rotating electrical mechanisms is a three-phase rotating electrical mechanism, first-phase terminals of the plurality of the three-phase rotating electrical mechanisms are connected in parallel or in series, second-phase terminals of the plurality of the three-phase rotating electrical mechanisms are connected in parallel or in series, and third-phase terminals of the plurality of the three-phase rotating electrical mechanisms are connected in parallel or in series.

7. The driving device for the vehicle according to claim 3, wherein the plurality of the rotating electrical mechanisms are arranged at regular intervals in a circumferential direction of the input shaft of the transmission apparatus.

8. The driving device for the vehicle according to claim 3, wherein either a single-phase rotating electrical mechanism or a three-phase rotating electrical mechanism is used as each of the plurality of the rotating electrical mechanisms.

9. The driving device for the vehicle according to claim 8, wherein the three-phase rotating electrical mechanism is used as each of the plurality of the rotating electrical mechanisms, and first-phase terminals of the plurality of the three-phase rotating electrical mechanisms are connected in parallel, second-phase terminals of the plurality of the three-phase rotating electrical mechanisms are connected in parallel, and third-phase terminals of the plurality of the three-phase rotating electrical mechanisms are connected in parallel.

10. The driving device for the vehicle according to claim 3, wherein the plurality of the rotating electrical mechanisms are configured with a synchronous rotating electrical mechanism and an inductive rotating electrical mechanism.

11. The driving device for the vehicle according to claim 10, wherein the synchronous rotating electrical mechanism and the inductive rotating electrical mechanism are connected in series.

12. The driving device for the vehicle according to claim 2, wherein the rotating electrical mechanism includes a plurality of rotating electrical mechanisms and the plurality of the rotating electrical mechanisms are arranged on a concentric circle having the axis of the input shaft of the transmission apparatus as a center point.

13. The driving device for the vehicle according to claim 4, wherein the rotating electrical mechanism includes three single-phase rotating electrical mechanisms, which are connected so as to generate a three-phase electric current.

14. The driving device for the vehicle according to claim 4, wherein each of the plurality of the rotating electrical mechanisms is a three-phase rotating electrical mechanism, first-phase terminals of the plurality of the three-phase rotating electrical mechanisms are connected in parallel or in series, second-phase terminals of the plurality of the three-phase rotating electrical mechanisms are connected in parallel or in series, and third-phase terminals of the plurality of the three-phase rotating electrical mechanisms are connected in parallel or in series.

15. The driving device for the vehicle according to claim 4, wherein the plurality of the rotating electrical mechanisms are arranged at regular intervals in a circumferential direction of the input shaft of the transmission apparatus.

16. The driving device for the vehicle according to claim 5, wherein the plurality of the rotating electrical mechanisms are arranged at regular intervals in a circumferential direction of the input shaft of the transmission apparatus.

17. The driving device for the vehicle according to claim 6, wherein the plurality of the rotating electrical mechanisms are arranged at regular intervals in a circumferential direction of the input shaft of the transmission apparatus.
